(19) United States
(12) Patent Application Publication
(10) Pub. No.: US 2018/0098388 A1
(43) Pub. Date: Apr. 5, 2018

(54) COIL ASSEMBLY FOR INDUCTION HEATING DEVICE AND INDUCTION HEATING DEVICE COMPRISING SAME

(71) Applicants: POSCO, Pohang-si (KR); PSTEK CO., LTD., Anyang-si (KR)

(72) Inventors: Hee-Tae JEONG, Gwangyang-si (KR); Byoung-Gee SUNG, Anyang-si (KR); Sang-Hyeon LEE, Pohang-si (KR); Hwan-Jin SUNG, Anyang-si (KR); Hwan-Ho SEONG, Anyang-si (KR)

(73) Assignees: POSCO, Pohang-si (KR); PSTEK CO., LTD., Anyang-si (KR)

(21) Appl. No.: 15/566,820

(22) PCT Filed: Dec. 4, 2015
(86) PCT No.: PCT/KR2015/013268

§ 371 Date: Oct. 16, 2017

(30) Foreign Application Priority Data
Apr. 16, 2015 (KR) 10-2015-0054070

(51) Int. Cl. H05B 6/36; H05B 6/52

(52) U.S. Cl. CPC H05B 6/362; H05B 6/42; H05B 6/52; H05B 6/365

(57) ABSTRACT

A coil assembly for an induction heating device comprises: a first coil part which has, on one surface thereof, a first cooling-pipe insertion groove indented to the inside thereof; a first cooling pipe coupled to the first cooling-pipe insertion groove so that a part of the outer surface can be exposed; a second coil part which is disposed to be opposite to one surface of the first coil part provided with the first cooling-pipe insertion groove and has, on one surface opposite to the one surface of the first coil part, a second cooling-pipe insertion groove indented to the inside thereof; and a second cooling pipe coupled to the second cooling-pipe insertion groove so that a part of the outer surface can be exposed.

### TECHNICAL FIELD

The present disclosure relates to a coil assembly for an induction heating device and an induction heating device including the same.

### BACKGROUND ART

An induction heating device is a device forming a strong alternating magnetic field to form an induced current in a heated member by electromagnetic induction so as to heat the heated member.

An induction heating device for heating a conductive plate such as a steel plate, or the like, is generally divided into two types, that is, a longitudinal heating coil (LF) and a transverse heating coil (TF). The longitudinal heating coil is a device in which a heating coil surrounds the conductive plate, and an induction current flows in the heating coil, to generate magnetic flux in a longitudinal direction of a heated member. The transverse heating coil is a device for heating in which a conductive plate traverses magnetic flux flowing in heating coils on both sides thereof, so that an induction current is generated in a plane of the conductive plate.

A longitudinal heating coil requires a high frequency when heating a thin material, so that it is problematic to heat the thin material. However, the transverse heating coil has a higher degree of heating efficiency, even at a lower frequency than the longitudinal heating coil.

In order to increase the heating efficiency in the transverse heating coil, a gap between a heating coil and a conductive plate should be narrow, so the longitudinal cross sectional area of the heating coil should be designed to be wide.

If a heating coil is regarded as being a general transformer, a voltage across a coil is proportional to the number of turns of the coil, due to characteristics of a transformer. As the number of turns of the coil increases, an applied voltage also rises. Therefore, a problem such as insulator breakdown between windings, called a coil body, due to a high voltage, may occur. Since a voltage and a current are in inverse proportion at the same level of power, it is desirable to transmit energy to a conductive plate while protecting a coil by decreasing the number of turns of a coil to reduce a coil voltage and increasing a current.

On the other hand, when a coil is manufactured, in the case of significantly high capacity equipment, if only a copper pipe is used to manufacture a coil, in order to solve a high calorific value, a line in which cooling water flows in and out should be additionally disposed for each middle portion of a coil. Thus, a significant amount of welding work maybe required. If a welding area is increased, leakage accidents occur frequently. Moreover, due to the characteristics of the equipment in which a large current flows, it may lead to a significantly large amount of arc damage. Thus, a problem of a serious degree of recovery costs may occur.

FIG. 1 is an exemplary view illustrating a heating coil according to the related art.

With reference to FIG. 1, a heating coil according to the related art is a simple air-core type heating coil in which a coil and a cooling pipe are integrated. Thus, the heating coil has a large amount of heat and the coil has a small longitudinal cross sectional area. Moreover, since a cooling water intake and exhaust line is further disposed in the middle of the coil, a welding operation for branching intermediate cooling water is required. Therefore, a leakage current is frequent, and an electric current may flow in a weld area, so the weld area may be affected by surface resistance, which may frequently cause arc damage.

### DISCLOSURE

### Technical Problem

An aspect of the present disclosure may provide a coil assembly for an induction heating device, improving a longitudinal cross sectional area of a coil, and preventing leakage of cooling water, and an induction heating device including the same.

### Technical Solution

According to an aspect of the present disclosure, a coil assembly for an induction heating device includes a first coil part having a first cooling pipe insertion groove, indented into the inside thereof, in one surface, a first cooling pipe combined with the first cooling pipe insertion groove such that a portion of an outer surface is exposed, a second coil part disposed opposite to one surface of the first coil part provided with the first cooling pipe insertion groove, and having a second cooling pipe insertion groove, indented into the inside thereof, in one surface opposite to one surface of the first coil part, and a second cooling pipe combined with the second cooling pipe insertion groove such that a portion of an outer surface is exposed.

The first coil part and the second coil part may include a plurality of heating conductors arranged side by side, and a connecting conductor connecting one ends of a heating conductor provided as the plurality of heating conductors to each other.

The heating conductor and the connecting conductor of the first coil part may be disposed opposite to the heating conductor and the connecting conductor of the second coil part.

The first cooling pipe and the second cooling pipe may be provided continuously in the heating conductor and the connecting conductor.

The other end of the heating conductor of the first coil part and the second coil part may be provided with a coupling part for coupling the first coil part and the second coil part.

The heating conductor of the first coil part may include a first heating conductor and a second heating conductor, the heating conductor of the second coil part may include a third heating conductor and a fourth heating conductor, opposite to the first heating conductor and the second heating conductor, respectively, and the coupling part may be provided in the other end of the first heating conductor and the other end of the fourth heating conductor or the other end of the second heating conductor and the other end of the third heating conductor.

The coupling part provided in the first coil part and the coupling part of the second coil part may be screw-coupled to each other.

A gap between the coupling part provided in the first coil part and the coupling part provided in the second coil part may be provided with an insulating member.

The first cooling pipe and the second cooling pipe may be disposed in the inside of the coupling part.

The first cooling pipe insertion groove and the second cooling pipe insertion groove may be provided to have shapes corresponding to outer surfaces of the first cooling pipe and the second cooling pipe, respectively.

The first cooling pipe and the second cooling pipe may be press-fit into the first cooling pipe insertion groove and the second cooling pipe insertion groove, respectively.

According to another aspect of the present disclosure, an induction heating device includes the coil assembly for an induction heating device, a power supply coupled to a first coil part and a second coil part to supply AC power, and a cooling pump coupled to a first cooling pipe and a second cooling pipe to supply cooling water.

The coil assembly for an induction heating device may be provided as a pair of coil assemblies for an induction heating device disposed to be spaced apart from each other, with a conductive plate passing between the pair of coil assemblies for an induction heating device.

The coil assembly for an induction heating device may be disposed to intersect a direction in which the conductive plate is supplied.

### Advantageous Effects

According to an exemplary embodiment in the present disclosure, in a coil assembly for an induction heating device and an induction heating device, a weld zone is reduced in a coil, so heating efficiency may be improved and leakage may be prevented.

### DESCRIPTION OF DRAWINGS

FIG. 1 is an exemplary view illustrating a heating coil according to the related art.

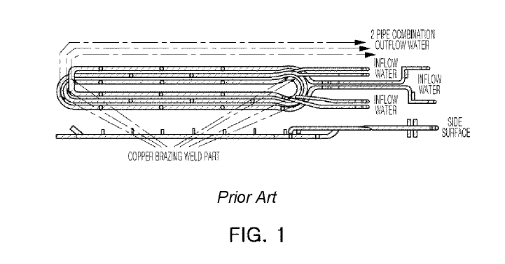

FIG. 2 is a schematic exploded perspective view of a coil assembly for an induction heating device according to an exemplary embodiment.

FIG. 3 is a schematic cross-sectional view taken along line A-A′ of FIG. 2.

FIG. 4 is a schematic side view of an induction heating device in which a core is detached from a coil assembly for an induction heating device according to an exemplary embodiment.

FIG. 5 is a schematic enlarged view of portion B of FIG. 2.

FIG. 6 is a schematic cross-sectional view taken along line C-C′ of FIG. 5.

### BEST MODE FOR INVENTION

Prior to the description of the present invention, terms and words used in the present specification and claims to be described below should not be construed as limited to ordinary or dictionary terms, and should be construed in accordance with the technical idea of the present invention based on the principle that the inventors can properly define their own inventions in terms of terms in order to best explain the invention. Therefore, the embodiments described in the present specification and the configurations illustrated in the drawings are merely the most preferred embodiments of the present invention and are not intended to represent all of the technical ideas of the present invention, and thus should be understood that various equivalents and modifications may be substituted at the time of the present application.

Hereinafter, preferred embodiments of the present invention will be described in detail with reference to the accompanying drawings. In this case, in the drawings, the same components are denoted by the same reference symbols as possible. Further, the detailed description of well-known functions and constructions which may obscure the gist of the present invention will be omitted. For the same reason, some of the elements in the accompanying drawings are exaggerated, omitted, or schematically illustrated, and the size of each element does not entirely reflect the actual size.

In addition, in the present specification, the expressions such as an upper side, a lower side, a side face, and the like, are described based on the drawings and may be expressed differently when the direction of the corresponding object is changed.

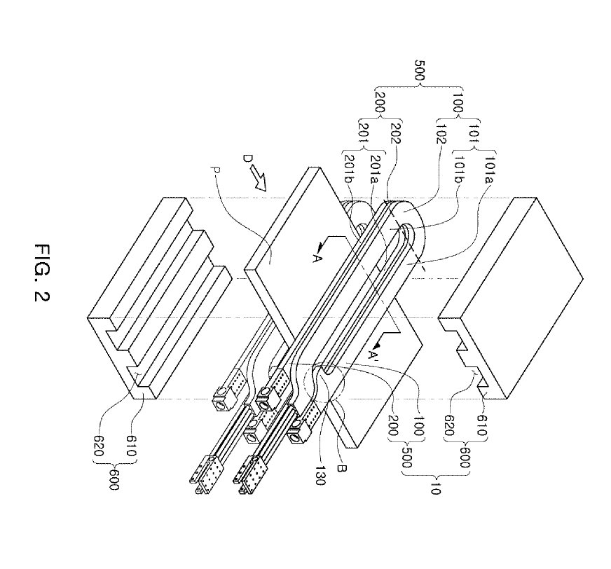

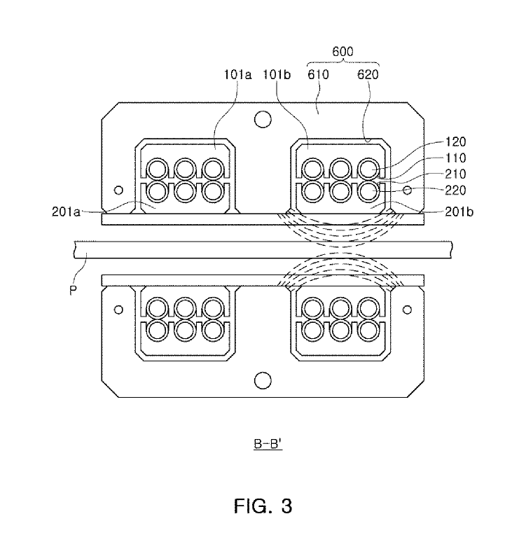

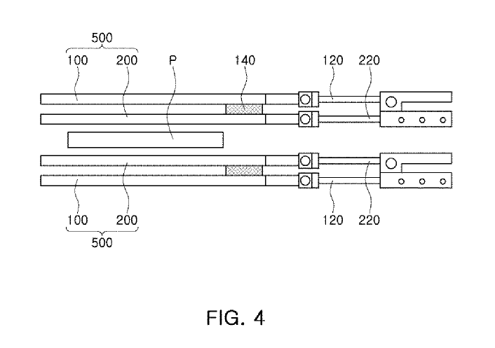

FIG. 2 is a schematic exploded perspective view of an induction heating device according to an exemplary embodiment, FIG. 3 is a schematic cross-sectional view taken along line A-A′ of FIG. 2, and FIG. 4 is a schematic side view of an induction heating device in which a core is detached from an induction heating device according to an exemplary embodiment.

With reference to FIGS. 2 through 4, an induction heating device 10 according to an exemplary embodiment may include a coil assembly for an induction heating device 500, a separate power supply applying AC power to the coil assembly for an induction heating device 500, and a cooling pump coupled to the coil assembly for an induction heating device 500 and supplying cooling water.

The coil assembly for an induction heating device 500 may include a first coil part 100 and a second coil part 200, and a separate power supply (not shown) supplying AC power may be connected to the first coil part 100 and the second coil part 200.

The first coil part 100 may be provided to have a U-shape as a whole, and a material therefor may preferably be a metal material with high conductivity. For example, the first coil part 100 may be formed of a 99% pure electrolytic tough pitch (ETP) copper wide flare material.

In one surface of the first coil part 100, a first cooling pipe insertion groove 110, indented into the inside thereof, may be provided. The first cooling pipe insertion groove 110, provided as at least one first cooling pipe insertion groove, may be continuously arranged along one surface of the first coil part 100, and may be manufactured by cutting into one surface of the first coil part 100, or may be manufactured at the same time as the first coil part 100.

A first cooling pipe 120 may be combined with the first cooling pipe insertion groove 110. Here, the first cooling pipe insertion groove 110 may be provided to have a shape corresponding to an outer surface of the first cooling pipe 120, and the first cooling pipe 120 may be press-fitted into the first cooling pipe insertion groove 110. However, a method in which the first cooling pipe is combined with the first cooling pipe insertion groove 110 is not limited to press-fitting, and various methods commonly used in the art to which the present invention belongs may be employed, such as welding, or the like.

The first coil part 100 may include a plurality of heating conductors 101 arranged to intersect a direction in which a conductive plate P is supplied, and a connecting conductor 102 connecting one ends of a heating conductor 101, by way of example. Here, the direction in which the conductive plate P is supplied is indicated by an arrow and the letter ‘D’ in FIG. 2.

The heating conductor 101 may be provided as a plurality of heating conductors arranged side by side, and may include a first heating conductor 101a and a second heating conductor 101b, by way of example.

One end of the heating conductor 101 may be provided with the connecting conductor 102 connecting two heating conductors 101. Here, the heating conductor 101 and the connecting conductor 102 may be manufactured as separate members and coupled together by a method such as welding, or the like, or may be integrally molded at the same time during manufacture.

One surface of the first coil part 100, in detail, one surface of the heating conductor 101 and the connecting conductor 102 may be provided with the first cooling pipe insertion groove 110, indented into the inside thereof. The first cooling pipe insertion groove 110 may be provided continuously along one surface of the first coil part 100. In other words, the first cooling pipe insertion groove 110 may be provided continuously in one surface of the first heating conductor 101a, the connecting conductor 102, and the second heating conductor 101b.

Meanwhile, as previously described, a method of manufacturing the first cooling pipe insertion groove 110 may be a cutting machining process. As described above, when the first cooling pipe insertion groove 110 for coupling of the first cooling pipe 120 is cutting machined in one surface of the first coil part 100 in advance, and the first cooling pipe 120 is press-fitted thereinto, the first cooling pipe 120 may be tightly coupled to the first coil part 100 during indentation. In addition, only a small amount of additional soldering and brazing operations may be required.

Thus, a welding work area may be significantly reduced, and an effect of surface resistance, slightly increased by welding materials, may be not significant, so heating efficiency may be improved.

In addition, a degree of current flowing to a weld zone of a cooling pipe is significantly reduced, so a risk caused by internal leakage may be reduced. Moreover, stability of the use of a coil part in a harsh environment such as a steel processing line may be improved.

At least one first cooling pipe 120 may be combined with the first cooling pipe insertion groove 110. In this case, the first cooling pipe 120 may be combined with the first cooling pipe insertion groove 110 while a portion of an outer surface is exposed externally. In other words, in the first cooling pipe 120, a portion of an outer surface maybe exposed to one surface of the first cooling pipe insertion groove 110. In this case, the first cooling pipe 120 may be provided continuously in one surface of the first coil part 100 along the first cooling pipe insertion groove 110, and may be provided in a U-shape as a whole. In addition, the first cooling pipe 120 may be connected to a separate cooling pump (not shown), and the cooling pump may supply cooling water to the first cooling pipe 120.

Thus, when the first coil part 100 is heated, the first cooling pipe 120 may allow the first coil part 100, having been heated, to be cooled.

Meanwhile, the other end of the first coil part 100, that is, an end in which the connecting conductor 102 is not provided, may be provided with a coupling part 130 for coupling of the second coil part 200 which will be described later.

The coupling part 130 may be coupled to a coupling part 230 of the second coil part 200 which will be described later, and a detailed description thereof will be provided later.

The second coil part 200 may be disposed opposite to one surface of the first coil part 100 provided with the first cooling pipe insertion groove 110, and one surface opposite to one surface of the first coil part 100 may be provided with a second cooling pipe insertion groove 210, indented into the inside thereof.

In addition, a second cooling pipe 220 may be combined with the second cooling pipe insertion groove 210. In this case, a portion of an outer surface of the second cooling pipe 220 maybe exposed to one surface of the second coil part 200. Thus, the outer surface of the first cooling pipe 120, having been exposed, may be provided to opposite to the outer surface of the second cooling pipe 220, having been exposed.

The second coil part 200 may include a third heating conductor 201a and a fourth heating conductor 201b opposite to the first heating conductor 101a and the second heating conductor 101b of the first coil part 100, respectively, byway of example, and the third heating conductor 201a and the fourth heating conductor 201b may be connected by a connecting conductor 202. In addition, the connecting conductor 202 may be disposed opposite to the connecting conductor 202 of the first coil part 100.

Here, the second coil part 200 may be provided to have the same shape as that of the first coil part 100 described previously. In other words, with reference to FIG. 4, the second coil part 200 maybe provided symmetrically with respect to the first coil part 200 based on the conductive plate P.

Thus, a detailed description of the second coil part 200 is omitted and replaced with the detailed description of the first coil portion 100.

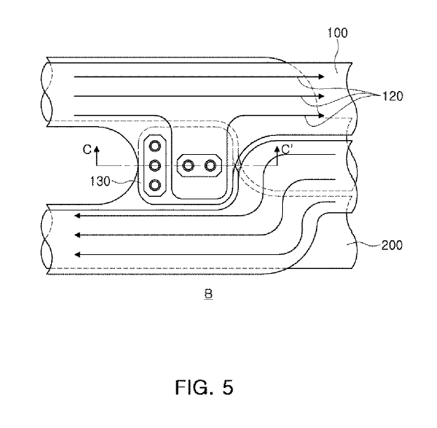

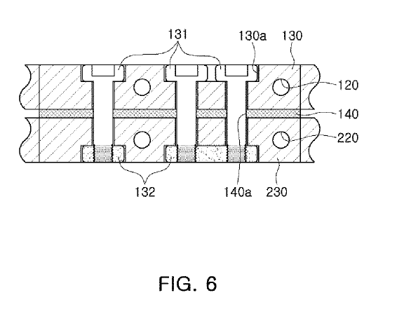

Meanwhile, the coupling parts 130 and 230 may be coupled to the first coil part 100 and the second coil part 200, respectively. As the coupling parts 130 and 230 are screw-coupled, the first coil part 100 and the second coil part 200 may be coupled to each other. Hereinafter, the coupling relationship between the first coil part 100 and the second coil part 200 will be described with reference to FIGS. 5 and 6.

FIG. 5 is an enlarged view of portion B of FIG. 2, and FIG. 6 is a schematic cross-sectional view taken along line C-C′ of FIG. 5. With reference to FIGS. 5 and 6, the coupling parts 130 and 230 may be provided in the other end in which the connecting conductors 102 and 202 of the first coil part 100 and the second coil part 200 are not provided, respectively.

In this case, the coupling parts 130 and 230 may be provided in the first heating conductor 101a of the first coil part 100 and the fourth heating conductor 201b of the second coil part 200, or maybe provided in the second heating conductor 101b of the first coil part 100 and the third heating conductor 201a of the second coil part 200.

In addition, in a heating conductor provided as a pair of heating conductors, the coupling parts 130 and 230 of one heating conductor may be provided to protrude toward the other heating conductor, and a plurality of screw holes 130a may be provided therein.

A screw hole 130a is provided with a male thread 131 and a female thread 132, the first coil part 100 and the second coil part 200 are screw-coupled.

Here, an insulating member 140 may be provided between the coupling part 130 of the first coil part 100 and the coupling part 230 of the second coil part 200. The insulating member 140 is provided as an insulator, thereby preventing a phenomenon in which the first coil part 100 and the second coil part 200 are electrically short-circuited. The insulating member 140 may be provided with at least one screw through hole 140a.

Meanwhile, the first cooling pipe 120 and the second cooling pipe 220 may be disposed in the coupling parts 130 and 230. In other words, a cooling pipe passing through the heating conductors 101 and 201 may pass through the inside of the coupling parts 130 and 230.

However, in a similar manner to the heating conductors 101 and 201, as a portion of an outer surface of the first cooling pipe 120 and the second cooling pipe 220 is exposed, the first cooling pipe 120 and the second cooling pipe 220 may be coupled to the coupling parts 130 and 230.

As described above, the first coil part 100 and the second coil part 200 are screw-coupled through the coupling part 130. Thus, the first coil part 100 and the second coil part 200 may be easily coupled to each other without a brazing process performed by a skilled welding technician, and replacement and repair may be easily performed, as advantages.

Meanwhile, a core 600 may be coupled to the coil assembly for an induction heating device 500 to allow the other surface of the second coil part 200, which is not opposite to the first coil part 100, to be exposed externally.

As an example, a body part 610 of the core 600 may be provided with an accommodating groove 620 indented into the inside thereof to accommodate the coil part. Here, the accommodating groove 620 is provided in a U-shape as a whole, so the first coil part 100 and the second coil part 200 may be accommodated, and the other surface of the second coil part 200 may be exposed externally.

Here, the conductive plate P may pass below the other surface of the second coil part 200, and the coil assembly for an induction heating device 500 may be disposed to intersect a direction in which a conductive plate is supplied.

Moreover, the coil assembly for an induction heating device 500 maybe provided as a pair of coil assemblies. In other words, the coil assembly for an induction heating device 500 may be provided as two coil assemblies as a pair, spaced apart from each other. The conductive plate P may pass between the coil assemblies for an induction heating device.

As described above, when the coil assemblies for an induction heating device 500 are disposed in both surfaces of the conductive plate P, heating efficiency of the conductive plate P may be improved.

While the present disclosure has been particularly shown and described with reference to exemplary embodiments thereof, but is not limited thereto. It will be apparent to those skilled in the art that various changes and modifications thereof may be made within the spirit and scope of the present disclosure, and therefore, it is to be understood that such changes and modifications belong to the scope of the appended claims.

1. A coil assembly for an induction heating device, comprising:
a first coil part having a first cooling pipe insertion groove, indented into the inside thereof, in one surface;
a first cooling pipe combined with the first cooling pipe insertion groove such that a portion of an outer surface is exposed;
a second coil part disposed opposite to one surface of the first coil part provided with the first cooling pipe insertion groove, and having a second cooling pipe insertion groove, indented into the inside thereof, in one surface opposite to one surface of the first coil part; and
a second cooling pipe combined with the second cooling pipe insertion groove such that a portion of an outer surface is exposed.

2. The coil assembly for an induction heating device of claim 1, wherein the first coil part and the second coil part include a plurality of heating conductors arranged side by side, and a connecting conductor connecting one ends of a heating conductor provided as the plurality of heating conductors to each other.

3. The coil assembly for an induction heating device of claim 2, wherein the heating conductor and the connecting conductor of the first coil part are disposed opposite to the heating conductor and the connecting conductor of the second coil part.

4. The coil assembly for an induction heating device of claim 2, wherein the first cooling pipe and the second cooling pipe are provided continuously in the heating conductor and the connecting conductor.

5. The coil assembly for an induction heating device of claim 2, wherein the other end of the heating conductor of the first coil part and the second coil part is provided with a coupling part for coupling the first coil part and the second coil part.

6. The coil assembly for an induction heating device of claim 5, wherein the heating conductor of the first coil part includes a first heating conductor and a second heating conductor, the heating conductor of the second coil part includes a third heating conductor and a fourth heating conductor opposite to the first heating conductor and the second heating conductor, respectively, and the coupling part is provided in the other end of the first heating conductor and the other end of the fourth heating conductor or the other end of the second heating conductor and the other end of the third heating conductor.

7. The coil assembly for an induction heating device of claim 5, wherein the coupling part provided in the first coil part and the coupling part provided in the second coil part are screw-coupled to each other.

8. The coil assembly for an induction heating device of claim 7, wherein a gap between the coupling part provided in the first coil part and the coupling part provided in the second coil part is provided with an insulating member.

9. The coil assembly for an induction heating device of claim 5, wherein the first cooling pipe and the second cooling pipe are disposed in the inside of the coupling part.

10. The coil assembly for an induction heating device of claim 1, wherein the first cooling pipe insertion groove and the second cooling pipe insertion groove are provided to have shapes corresponding to outer surfaces of the first cooling pipe and the second cooling pipe, respectively.

11. The coil assembly for an induction heating device of claim 10, wherein the first cooling pipe and the second cooling pipe are press-fit into the first cooling pipe insertion groove and the second cooling pipe insertion groove, respectively.

12. An induction heating device, comprising:
the coil assembly for an induction heating device according to claim 1;
a power supply coupled to a first coil part and a second coil part to supply alternating current (AC) power; and
a cooling pump coupled to a first cooling pipe and a second cooling pipe to supply cooling water.

13. The induction heating device of claim 12, wherein the coil assembly for an induction heating device is provided as a pair of coil assemblies for an induction heating device disposed to be spaced apart from each other, with a conductive plate passing between the pair of coil assemblies for an induction heating device.

14. The induction heating device of claim 13, wherein the coil assembly for an induction heating device is disposed to intersect a direction in which the conductive plate is supplied.
